(19) United States
(12) Patent Application Publication
(10) Pub. No.: US 2006/0038825 A1
(43) Pub. Date: Feb. 23, 2006

(54) Display apparatus and display control method for display apparatus

(75) Inventor: Yukihiko Sakashita, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/202,077

(22) Filed: Aug. 12, 2005

(30) Foreign Application Priority Data
Aug. 23, 2004 (JP) 2004-242326

(51) Int. Cl. G09G 5/02

(52) U.S. Cl. 345/592

(57) ABSTRACT

A display corrects color unevenness occurring when single colors (R, G or B) are displayed. The display apparatus uses a color mixing ratio conversion unit that determines a mixing ratio of at least two video signals based on display position information in the single color image.

### BACKGROUND OF THE INVENTION

1. Field of the Invention

The present invention relates to a display apparatus for improving color unevenness and a display control method for the display apparatus, particularly, a rear projection type display apparatus.

2. Related Art

An apparatus for correcting color unevenness of a display apparatus has been heretofore proposed such as an apparatus in which a display screen is divided into blocks to even a brightness level of the divided blocks for correcting color unevenness occurring on the display screen (JP-A-10-84551, for example).

A conventional color unevenness correction apparatus will be described now on the basis of FIG. 7. FIG. 7 shows a structure of a color unevenness correction apparatus disclosed in JP-A-10-84551.

In FIG. 7, a video signal in a single color is inputted from a video signal input 701. The inputted signal is amplified in an amplifier 702 to carry out V-T correction corresponding to a characteristic of a liquid crystal panel 708 in a V-T correction circuit 703. A color unevenness correction signal generated in a color unevenness correction signal generating circuit 710 is then added in a color unevenness correction signal adder 704 through a D/A converter 711 and an amplifier 712 for color unevenness correction. The color unevenness correction signal is generated with timing corresponding to a display position in a timing generating circuit 709 on the basis of an H synchronizing signal and a V synchronizing signal, which are inputted into an H synchronizing signal input 713 and a V synchronizing signal input 714.

A signal outputted from the color unevenness correction signal adder 704 is a signal negatively or positively converted into by unit of a inverting amplifier 705 or a noninverting amplifier 706. The polarity of the negatively or positively converted signal is switched with desirable timing in a polar electronic switch 707 to drive the liquid crystal panel 708.

In the case of a three-panel type projector, dispersion in brightness of respective colors on a display screen of liquid crystal panels is perceived as color unevenness due to a pile of three plates. Accordingly, providing respectively the above-mentioned correction circuits for the liquid crystal panels of respective colors allows the brightness unevenness of the respective panels, and thereby, the color unevenness to be reduced.

In a color unevenness correction method described in Background of The Invention, however, unevenness caused by color unevenness occurring when each single color of the RGB is displayed cannot be corrected since a correction signal is added to or subtracted from (or multiplied by) each signal of the RGB for correction.

### SUMMARY OF THE INVENTION

The invention is to solve the problems in the conventional techniques. An object of the invention is to provide a display apparatus with improved image quality, the display apparatus capable of correcting unevenness caused by color unevenness occurring when each single color of the RGB is displayed.

The invention includes the following structure in order to achieve the above object. That is to say, a display apparatus in accordance with the invention is
a display apparatus composed of a plurality of optical modulation elements respectively displaying different single color images base on a plurality of video signals and an optical system which synthesizes the different signal color images, the apparatus comprises:
a color mixing ratio conversion unit that determines a mixing ratio of at least two video signals among the plurality of video signals based on display position information in the single color image; and
driving units which respectively drive the plurality of optical modulation elements based on outputs from the color mixing ratio conversion unit.

The display apparatus in accordance with the invention is also
a display apparatus for displaying a color image based on video signals for a plurality of colors, comprises:
a position information generating unit for outputting display position information defining a display position in a display screen based on a synchronizing signal;
a coefficient memory unit for memorizing a correction coefficient at a correction point corresponding to a predetermined display position;
a coefficient interpolation unit for outputting a matrix coefficient corresponding to the display position in the display screen by interpolating the correction coefficient at a correction point corresponding to the display position;
a color mixing ratio conversion unit for executing a matrix operation of the video signals for a plurality of colors with the matrix coefficient, wherein the color mixing ratio conversion unit converts a mixing ratio of the video signals for a plurality of colors; and
a driving unit for outputting a driving signal based on an output from the color mixing ratio conversion unit.

Further, a display control method for a display apparatus in accordance with the invention is a display control method for a display apparatus, for displaying a color image based on video signals for a plurality of colors, comprises the steps of:
outputting display position information defining a display position in a display screen based on a synchronizing signal;
reading out a correction coefficient at a correction point corresponding to a predetermined display position based on the display position information;
outputting a matrix coefficient corresponding to the display position in the display screen by interpolating the correction coefficient at a correction point corresponding to the display position;
executing a matrix operation of the video signals for a plurality of colors with the outputted matrix coefficient; and
driving the display apparatus based on an output obtained by converting a mixing ratio of the video signals for a plurality of colors based on a result of the matrix operation.

### BRIEF DESCRIPTION OF THE DRAWINGS

FIG. 1 is a side sectional view of a rear projection type display apparatus in accordance with the embodiment;

FIG. 2 is a structural view of a projection type of display engine in accordance with the embodiment;

FIG. 3 is a block diagram of the rear projection type display apparatus in accordance with the embodiment;

FIG. 4 is a block diagram showing signal processing including a brightness unevenness and color unevenness correction unit of the rear projection type display apparatus in accordance with the embodiment;

FIG. 5 illustrates an example of a display screen;

FIG. 6 illustrates a color reproduction range; and

FIG. 7 is a block diagram of a conventional color unevenness correction circuit.

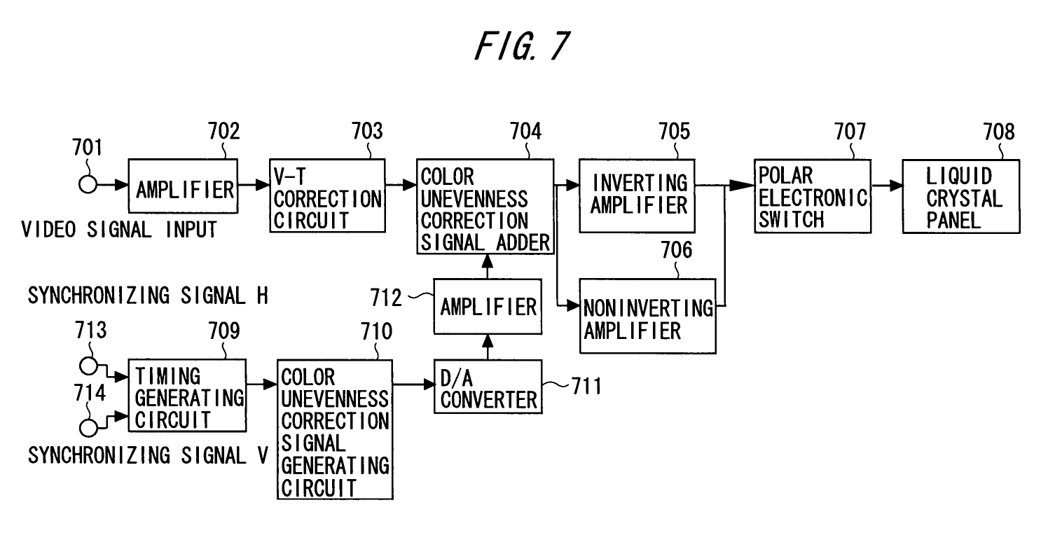

### DETAILED DESCRIPTION OF THE INVENTION

Now, best modes for executing the invention will be exemplified in detail, making reference to the drawings. Dimension, materials, shapes, relative arrangement and the like of components described in the embodiments, however, do not intend to limit the range of the invention to the above unless otherwise specified.

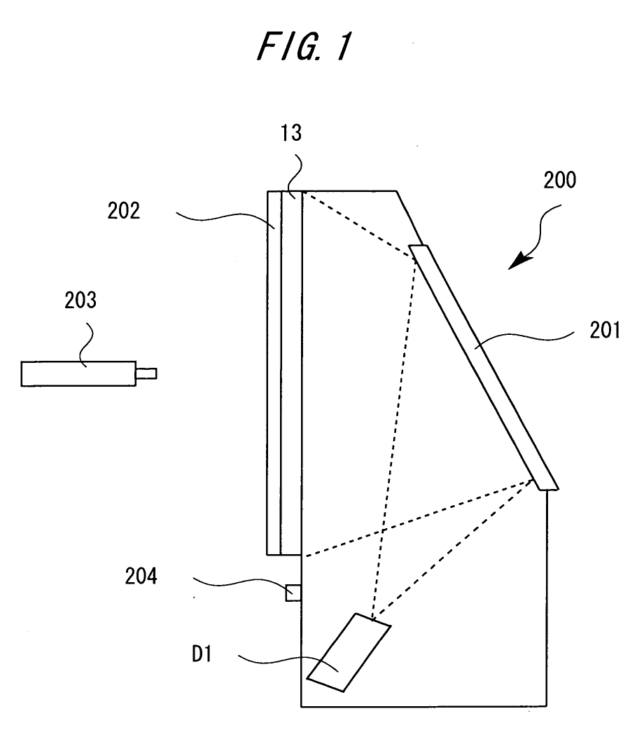

A rear projection type display apparatus 200 in accordance with the embodiment of the invention will be described with reference to FIG. 1. FIG. 1 is a side view of the rear projection type display apparatus in accordance with the embodiment.

An image projected from a projection type display engine D1 is reflected on a reflection mirror 201 to be projected from a back surface of a screen 13. A digitizer 202 is mounted to a front surface of the screen 13. A position coordinate inputted by unit of a digitizer pen 203 is inputted from a front surface of the screen 13 to a display apparatus 200. Various kinds of digitizer such as a digitizer of an optical type, a pressure-sensitive type, an ultrasonic type can be used as the digitizer 202. A brightness adjustment SW 204 is a switch for indicating brightness of a display screen.

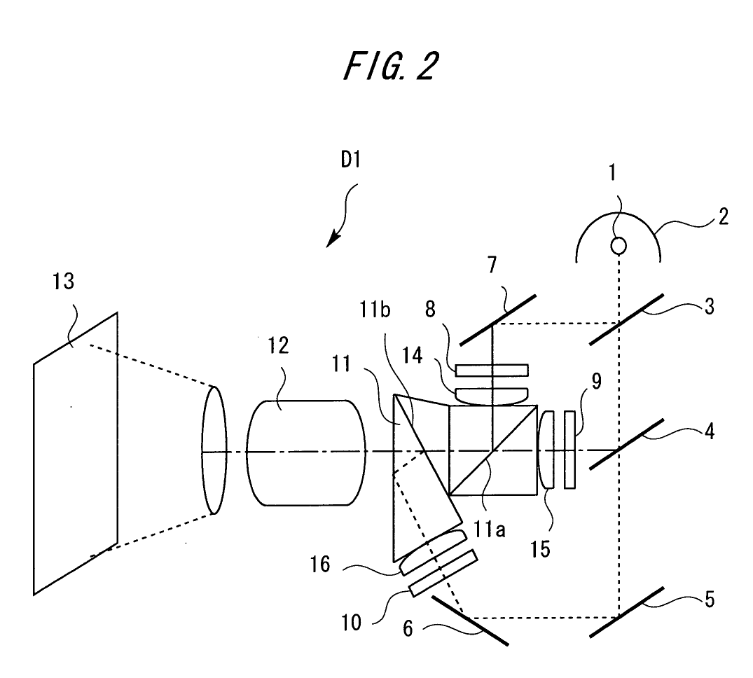

Next, an optical system in the projection type display engine D1 will be described. FIG. 2 illustrates a structure of an optical system in the projection type display engine D1.

In FIG. 2, white light emitted from a lamp 1 is converted into substantially parallel light by unit of a paraboloidal mirror 2 and a reflection mirror and a lens group, which are not shown in the drawing. The substantially parallel light is resolved in color by unit of dichroic mirrors 3 and 4, high reflection mirrors 5, 6 and 7 and a lens group not shown to be converged on liquid crystal panels 8, 9 and 10 provided for the respective colors.

The light incident on the liquid crystal panels 8, 9 and 10 is modulated by unit of the liquid crystal panels 8, 9 and 10 displaying an image so as to generate space modulation light corresponding to the display image. The modulated light in the respective colors is synthesized in color by unit of a color synthesis dichroic prism 11 to be enlarged for projection on the screen 13 through a projection lens group 12.

In the color synthesis dichroic prism 11, provided are two dichroic films 11a and 11b respectively disposed on a slant with respect to an optical axis so as not to intercross in the prism. The dichroic film 11a synthesizes the modulated light in two colors among the red, green and blue colors, which has a wavelength range different each other, using reflection and transmission functions thereof. The dichroic film 11b synthesizes the modulated light in two colors, which has been synthesized by unit of the dichroic film 11a, and the modulated light in the rest of colors, using reflection and transmission functions thereof. The modulated light so synthesized in color is emitted from an emitting surface of the prism 11 to the projection lens group 12.

Regular refraction lens groups 14, 15 and 16 are provided between the respective liquid crystal panels 8, 9 and 10 and the color synthesis dichroic prism 11 for the purpose of miniaturizing an optical system. Accordingly, the modulated light in respective colors, which is substantially parallel light having passed through the respective liquid crystal panels 8, 9 and 10, is subjected to a convergence operation in the regular refraction lens groups 14, 15 and 16 to be unparallelized. The unparallelized light is incident on the color synthesis dichroic prism 11.

Thus, incident angles of the light bundles on the dichroic films 11a and 11b are different between the left and right sides of a screen, for example. This causes difference in cut off wavelength in a spectrum and transmission in the dichroic films 11a and 11b, so that a problem occurs such that unevenness of a brightness or color chromaticity level (brightness unevenness or color unevenness) of the spectrum in respective colors appears in the left and right parts, for example, of the screen.

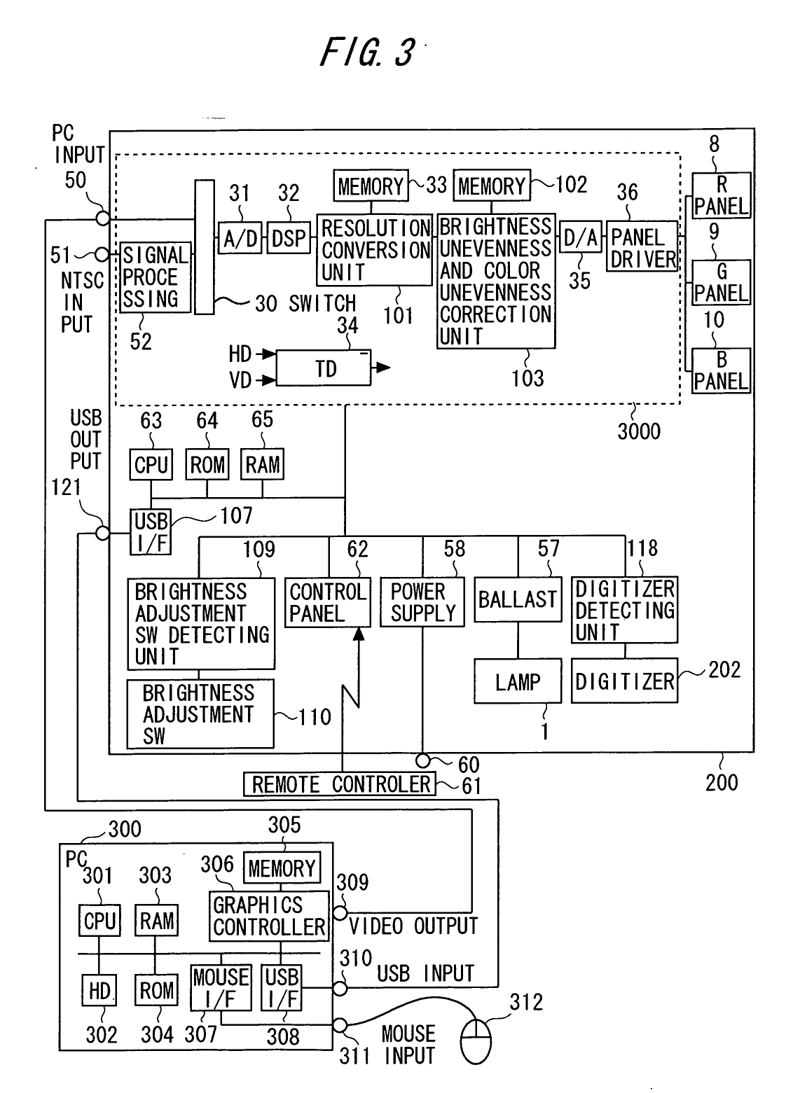

Electric signal processing in the display apparatus 200 in accordance with the embodiment will be now described. FIG. 3 is a block diagram of the back projection type display apparatus in accordance with the embodiment.

A shown in FIG. 3, the liquid crystal panels 8, 9 and 10 are connected to a video signal processing unit 3000.

In the video signal processing unit 3000, 30 denotes a switch while 31 denotes an A/D converter. Further, 32 denotes a DSP unit, 33 denotes a memory for holding current display data and data to be displayed in a subsequent frame, 34 denotes a timing generating circuit (TG), 101 denotes a resolution conversion unit, 102 denotes a memory for memorizing display data and correction data, which are used for color unevenness correction, 103 denotes a brightness unevenness and color unevenness correction unit, 35 denotes a D/A converter and 36 denotes a panel driver for supplying a signal applied to the respective liquid crystal panels 8, 9 and 10 and electric power.

In the DSP unit 32, carried out is display image processing such as adjustment in contrast or brightness, color conversion or the like.

In the block diagram of FIG. 3, shown is only an analog input signal. The invention, however, is not limited to the above. It goes without saying that providing an input terminal such as LVDS (low voltage differential signaling), TMDS (transition minimized differential signaling) and the like or a D4 terminal for a digital TV is also effective.

A signal processing circuit 52 performs signal processing such as decoding of an NTSC signal, noise reduction processing, band-limit filtering, signal level adjustment or the like.

Ballast 57 is a power supply for a lamp, which is connected to the lamp 1. A system power supply 58 is supplied with electric power from an AC inlet 60.

A remote controller 61 carries out various operations of the display apparatus 200 while a control panel 62 receives a signal from the remote controller 61.

A brightness adjustment SW detecting unit 109 detects an operation of a brightness adjustment SW 110. A digitizer detecting unit 118 detects a coordinate indicated by the digitizer 202.

A CPU 63 is connected to the video signal processing unit 3000, the control panel 62, the ballast 57, the brightness adjustment SW detecting unit 109, the digitizer detecting unit 118, a USB I/F 107 for executing driving control for the liquid crystal panels 8,9 and 10, the lamp 1 and the like or control for enlargement and/or reduction in size or movement of a display image.

In the embodiment, there is description that the brightness adjustment SW detecting unit 109, the digitizer detecting unit 118 and the USB I/F 107 are connected to the CPU 63, but may be built in the CPU 63 or arranged to be executed by a program.

The PC (personal computer) 300 includes a CPU 301, an HD (hard disk) 302, a RAM 303, a ROM 304, a memory 305, a graphics controller 306, a mouse I/F 307, a USB I/F 308 and the like and comprises a video output terminal 309, a USB input terminal 310 and a mouse input terminal 311. A mouse 312 is connected to the mouse input terminal 311.

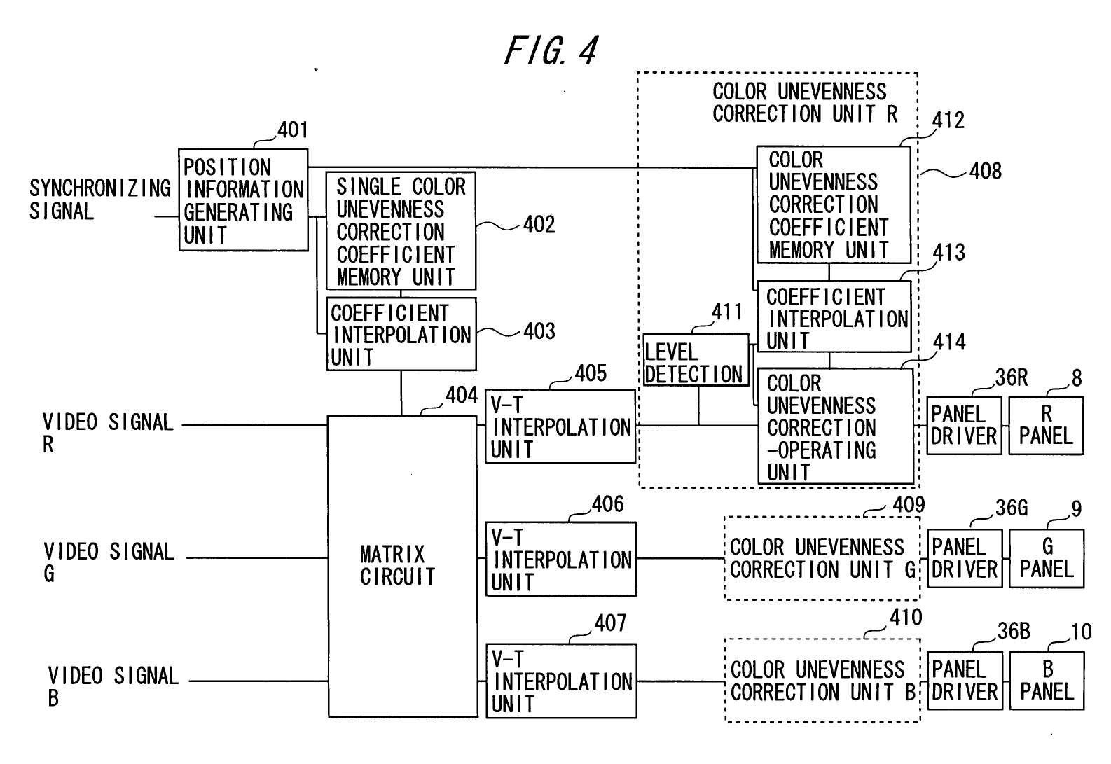

FIG. 4 is a block diagram showing in detail a signal processing system including the brightness unevenness and color unevenness correction unit 103 in accordance with the embodiment.

A position information generating unit 401, a single color unevenness correction coefficient memory unit 402 and a coefficient interpolation unit 403 form a conversion coefficient selecting unit while a matrix circuit 404 forms a mixing ratio converting unit. A V-T interpolation unit for an R panel 405, a V-T interpolation unit for a G panel 406, a V-T interpolation unit for a B panel 407, a color unevenness correction unit for the R 408, a color unevenness correction unit for the G 409 and a color unevenness correction unit for the B 410 form a color unevenness correcting unit for correcting color unevenness for every color.

Details of the color unevenness correction units 408, 409 and 410 will be described with an exemplification of the color unevenness correction unit for the R since structures of the above are similar to each other.

In the position information generating unit 401, horizontal counting and vertical counting are carried out on the basis of a horizontal synchronizing signal HSYNC and a vertical synchronizing signal VSYNC of a video signal to be displayed so as to generate position information indicating a display position in the display screen (image) in accordance with timing of the video signal and a correction signal. The position information generating unit 401 outputs a memory address corresponding to the position information to the color unevenness correction coefficient memorizing unit 402. The color unevenness correction coefficient memory unit 402 reads out a correction coefficient at a correction point corresponding to the display position in accordance with the memory address. The coefficient interpolation unit 403 interpolates the read correction coefficient at a correction point to output a matrix coefficient corresponding to the display position. In the matrix circuit 404, a video signal to be inputted is multiplied by the matrix coefficient obtained by interpolation in the coefficient interpolation unit 403 so as to correct color unevenness by mixing and outputting RGB signals to be inputted in accordance with a display position coordinate.

The V-T interpolation units 405, 406 and 407 carry out correction of a V-T curve in accordance with characteristics of the R liquid crystal panel 8, the G liquid crystal panel 9 and the B liquid crystal panel 10, respectively.

The color unevenness correction unit for the R panel 408, a color unevenness correction unit for the G panel 409 and a color unevenness correction unit for the B panel 410 add or subtract the correction coefficient to or from a signal to be outputted to the respective panels 8, 9 and 10 or multiply the correction coefficient and the signal to perform color unevenness correction.

The color unevenness correction unit for the R 408 will be described hereinafter as a representative of a color unevenness correction units 408, 409 and 410. In the color unevenness correction unit for the R 408, a level detection unit 411 detects a signal level of a video signal to be inputted to interpolate a color unevenness correction coefficient read out from the color unevenness correction coefficient memory unit 412 in accordance with the level in a coefficient interpolation unit 413. The interpolated color unevenness correction coefficient is added to or subtracted from an input signal in a color unevenness correction-operating unit 414.

There are two correction methods of: (1) evening brightness of the respective R, G and B panels 8, 9 and 10 displaying a single color to correct color unevenness in display with the three panels 8, 9 and 10 composed; and (2) changing balance between the respective R, G and B colors to carry out correction so that the color chromaticity would be evened without evening the brightness in displaying a single color. The latter method (2) has an advantage that the display brightness is less reduced as a whole.

Now, shown will be an example of setting correction data at a correction point in a screen horizontally and vertically segmented at a predetermined interval in the single color unevenness correction coefficient memory unit 402 or color unevenness correction coefficient memory unit 412, both of the units being for a matrix. In the embodiment, shown is a case that a video signal having 1024 dots×768 lines and meeting the XGA display standard is divided into nine points at 128-dot intervals in the horizontal direction and seven points at 128-line intervals in the vertical direction. In this case, correction data at 63 correction points per a screen is set in the RAM 102.

The memorized correction coefficient at a correction point is horizontally and vertically interpolated by the coefficient interpolation units 403 and 413 to reduce a memory amount.

It is also possible to memorize in the color unevenness correction coefficient memory unit 412 a correction coefficient for every input level in a gradation direction. Accordingly, in order to reduce a memory amount in the input level direction, an input level is divided, a correction coefficient corresponding to the divided input level is memorized, a level of a video signal to be inputted is detected in the level detection unit 411 and the coefficient is interpolated in the coefficient correction unit 413 for use.

As described above, the coefficient interpolation unit 403 performs interpolation in horizontally and vertically positional directions while the coefficient interpolation unit 413 carries out interpolation in horizontally and vertically positional directions and in a direction of a level of an input signal.

As an interpolation method in the coefficient interpolation units 403 and 413, various kinds of method such as nearest-neighbor interpolation, linear interpolation, cubic interpolation, spline interpolation and such may be used.

A principle of color unevenness correction in accordance with the embodiment will be now described. As mentioned above, unevenness caused by color unevenness occurring when each single color of the RGB is displayed cannot be corrected since a correction signal is added to or subtracted from (or multiplied by) the respective signals of the RGB for correction in the conventional color unevenness correction method.

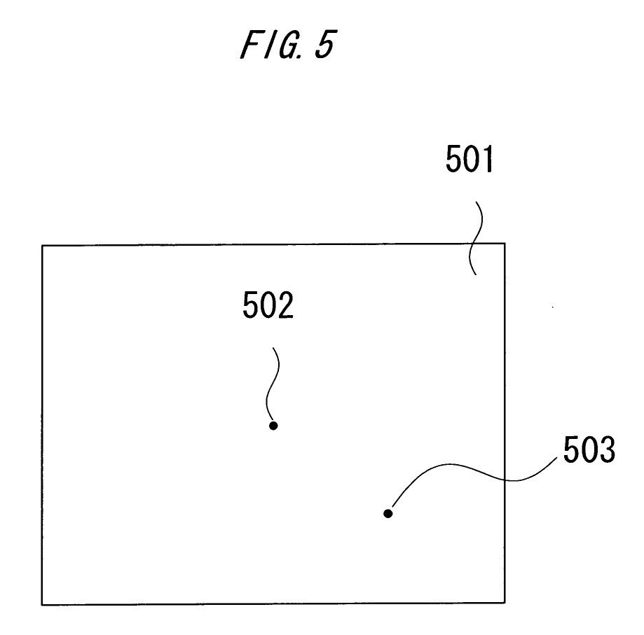

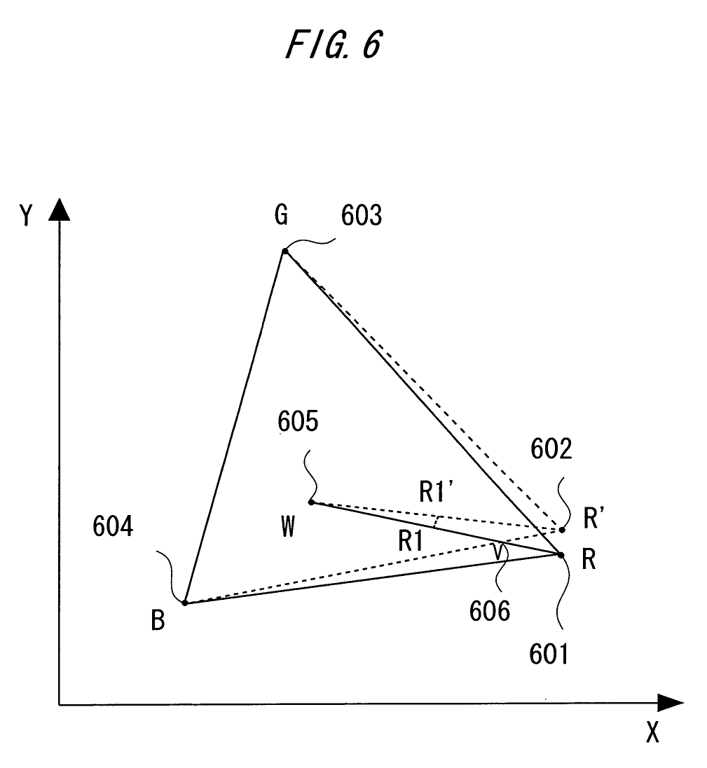

The color unevenness correction method in accordance with the embodiment will be described with FIGS. 5 and 6. FIG. 5 shows an example that a signal ((R, G, B)=(255, 0, 0), for example) is inputted only to the R panel among three of the R, G and B panels to carry out red display on a display screen 501. The color chromaticity of the displayed red color is different between a center part 502 and a lower-right part 503 of the display screen 501 even when a same signal is inputted since a filter characteristic is different depending on an angle incident on a dichroic mirror of an optical system. It is assumed here that the color chromaticity at the center part 502 is R (Xr, Yr) while the color chromaticity at the lower-right part 503 is R′ (Xr′, Yr′).

Assuming that the color chromaticity in display carried out by inputting a signal only to the G panel of the three-panel projection type display apparatus is G (Xg, Yg) and that the color chromaticity in display carried out by inputting a signal only to the B panel is B (Xb, Yb), a color reproduction range capable of display at the center part 502 of the display screen 501 is a triangle formed from a solid line connecting respective points of R601, G603 and B604 in an X-Y color chromaticity graph in FIG. 6. In FIG. 6, W605 denotes a coordinate of the color chromaticity of a white color in simultaneously displaying the respective RGB signals on the respective RGB panels.

Further, a color reproduction range at the lower-right part 503 of the display screen 501 is a triangle formed from a dotted line connecting respective points of R′602, G603 and B604 in FIG. 6.

As described above, the color reproduction range is different between the center part 502 and the lower-right part 503 and this causes color unevenness. Accordingly, a different color is displayed even when a video signal having a same value of (R, G, B) is inputted to the center part 502 and the lower-right part 503.

In the conventional color unevenness correction method, the R signal is only increased or decreased even when a color at the lower-right part 503 of the screen is corrected in accordance with a color at the center part 502 of the screen during display of a single color (the red color, for example) since a color unevenness correction signal is added to or multiplied by a signal of a single color for correction. Accordingly, a color in a line connecting the points W605 and R601 in the color reproduction range at the center part 502 of the screen cannot be reproduced although it is possible to reproduce a color in a line connecting the points W605 and R′602, so that color unevenness correction cannot be performed with high image quality.

In order to solve the problems lying in the conventional method, in the embodiment, a correction coefficient at a correction point for color unevenness correction, which corresponds to display position information from the position information generating unit 401, is read out from the single color unevenness coefficient memory unit 402, the correction coefficient is interpolated in accordance with the display position to output a matrix coefficient in the coefficient interpolation unit 403 and the matrix coefficient is supplied to the matrix circuit 404.

The color reproduction ranges at the center part 502 and the lower-right part 503 in FIG. 5 are different as shown in FIG. 6. In order to accord an axis W605-R′602 in the color reproduction range at the lower-right part 503 (a color axis in one color reproduction range) with an axis W605-R601 in the color reproduction range at the center part 502 (a color axis in the other color reproduction range), mixing a blue signal with a red signal to be displayed at the lower-right part 503 (conversion in mixing ratio) for display allows the axes to be moved to carry out color unevenness correction. Mixing a blue signal with a red signal, for example, allows color unevenness correction to be performed for the purpose of according a middle point R′1 in the axis W605-R′602 with a middle point R1 in the axis W605-R601.

As described above, changing the matrix coefficient supplied to the matrix circuit 404 in accordance with a display position so as to correspond to color unevenness and executing display with a ratio of mixing the respective RGB colors being changed allow color unevenness caused by color unevenness in displaying a single color to be corrected.

An input/output characteristic is expressed by the following formula:

$$[ \begin{matrix}Rout \\ Gout \\ Bout\end{matrix} ] = [ \begin{matrix}K11 & K12 & K13 \\ K21 & K22 & K23 \\ K31 & K32 & K33\end{matrix} ] [ \begin{matrix}Rin \\ Gin \\ Bin\end{matrix} ]$$

wherein (Rin, Gin, Bin) denotes an input signal to the matrix circuit 404 and (Rout, Gout, Bout) denotes an output signal from matrix circuit 404. Changing the matrix coefficient formed from K11 to K33 in the above formula in accordance with the display position allows color unevenness caused in display of a single color to be corrected.

Determining a value of K31 so as to output Rout and Bout for an input Rin in the above formula at a proper rate (conversion in mixing ratio) in displaying a red signal at the lower-right part 503, for example, allows correction to be performed.

Therefore, when there is difference in color chromaticity caused by difference in color reproduction range at a display position, which causes color unevenness in displaying a single color, a point in a color axis in one color reproduction range can be accorded with a point in a color axis in the other color reproduction range in an area where the color reproduction ranges overlap. For example, it is possible to accord a point in the axis W605-R′602 in the color reproduction range at the lower-right part 503 with a point in W605-V606 including a corresponding point in the axis W605-R601 in the color reproduction range at the center part 502.

As for an area where the color reproduction ranges do not overlap, performing correction so that the color chromaticity would be same as the color chromaticity to which the color axes accord each other within an area where the color reproduction ranges overlap allows color unevenness to be inconspicuous, and thereby, improved. Even in the case that there is no corresponding point in the axis W605-R601 in the color reproduction range at the center part 502, for example, a point in the axis W605-R′602 can be accorded with a point in an axis V606-R′602 to make the color unevenness inconspicuous and improved. That is to say, the color mixing rate conversion unit corrects the color chromaticity (converts a mixing ratio) so that a point in a color axis in one color reproduction range would be close to a point in a color axis in the other color reproduction range in an area where different color reproduction ranges overlap at different display positions in a display screen.

Further, executing correction so that only a part where the color reproduction ranges overlap at each display position would be used also allows the color chromaticity at the respective display positions to be completely accorded although the color reproduction range becomes narrow. Accordingly, the invention can be properly applied in accordance with a degree of dispersion in color unevenness or a purpose of using the display apparatus.

As described above, in accordance with the embodiment, it is possible to correct unevenness caused by color unevenness occurring when each single color of the RGB is displayed, the unevenness incapable of correction in the conventional method, so that a display apparatus with further high image quality can be provided.

It is also possible to accord a point in an axis G603-R′602 with a point in an axis G603-R601 in a manner similar to the above.

Further, in the embodiment, difference in angle incident on a dichroic film causes color unevenness in displaying a single color. The invention, however, is not limited to the above and may be applied to correction in color unevenness caused by another factor such as an optical system, a screen, a panel or the like.

Moreover, in the embodiment, described is a case that light different in incident angle is used in a color synthesis optical system for the purpose of miniaturizing an optical system. Difference, however, also appears in optical characteristic in the case of using light different in incident angle in a color division optical system for the purpose of improving efficiency in using light. This causes the above-mentioned color unevenness (color dispersion) in displaying a single color. The invention may be also applied to such a case in order to improve the color unevenness.

In addition, a back projection type display apparatus using a transmission type liquid crystal device is described in the embodiment. The invention, however, is not limited to the above and may be applied to a back and front projection type display apparatus using a DMD (digital micromirror device), an LCOS (liquid crystal on silicon/a reflection type liquid crystal device) or the like and various kinds of display apparatus such as a direct view type LCD, PDP, CRT, OLED (organic light emitting diode) or the like. The invention can be applied to correction in color unevenness caused by difference in color reproduction range in accordance with a position in a display screen and to improvement of image quality thereof.

In accordance with the invention, unevenness caused by color unevenness in displaying a single color can be corrected, and thereby, it is further possible to provide a display apparatus with high image quality.

This application claims priority from Japanese Patent Application No. 2004-242326 filed Aug. 23, 2004, which is hereby incorporated by reference herein.

1. A display apparatus comprising:
a plurality of optical modulation elements respectively displaying different single color images based on a plurality of video signals;
an optical system which synthesizes the different single color images;
a color mixing ratio conversion unit that determines a mixing ratio of at least two video signals among the plurality of video signals based on display position information in one of the single color images; and
driving units which respectively drive said plurality of optical modulation elements based on outputs from said color mixing ratio conversion unit.

2. A display apparatus according to claim 1, further comprising a color unevenness correction unit for correcting color unevenness for every single color based on an output from said color mixing ratio conversion unit.

3. A display apparatus for displaying a color image based on video signals for a plurality of colors, comprising:
a position information generating unit for outputting display position information defining a display position in a display screen based on a synchronizing signal;
a coefficient memory unit for memorizing a correction coefficient at a correction point corresponding to a predetermined display position;
a coefficient interpolation unit for outputting a matrix coefficient corresponding to the display position in the display screen by interpolating the correction coefficient at a correction point corresponding to the display position;
a color mixing ratio conversion unit for executing a matrix operation of the video signals for a plurality of colors with the matrix coefficient, wherein the color mixing ratio conversion unit converts a mixing ratio of the video signals for a plurality of colors; and
a driving unit for output a driving signal based on an output from the color mixing ratio conversion unit.

4. A display apparatus according to claim 3, further comprising:
a V-T correction unit for correcting a V-T curve for an output from said color mixing ratio conversion unit; and
a color unevenness correction unit for correcting color unevenness for the output from said V-T correction unit.

5. A display apparatus according to claim 3, wherein said color mixing ratio conversion unit determines the mixing ratio for mixing a color of a color axis with a color different from the color of the color axis in order to accord a point in the color axis in one color reproduction range with a point of the color axis in the other color reproduction range in an area where the different color reproduction ranges overlap at a display position in the display screen.

6. A display apparatus according to claim 3, wherein said color mixing ratio conversion unit determines a mixing ratio for mixing a color of a color axis with a color different from the color of the color axis in order to put a point in the color axis in one color reproduction range close to a point of the color axis in the other color reproduction range in an area where the different color reproduction ranges overlap at a display position in the display screen.

7. A display control method for a display apparatus, for displaying a color image based on video signals for a plurality of colors, comprising the steps of:
outputting display position information defining a display position in a display screen based on a synchronizing signal;
reading out a correction coefficient at a correction point corresponding to a predetermined display position based on the display position information;
outputting a matrix coefficient corresponding to the display position in the display screen by interpolating the correction coefficient at a correction point corresponding to the display position;
executing a matrix operation on the video signals for a plurality of colors with the outputted matrix coefficient; and
driving the display apparatus based on an output obtained by converting a mixing ratio of the video signals for a plurality of colors based on a result of the matrix operation.
